(19) United States
(12) Patent Application Publication
(10) Pub. No.: US 2024/0399486 A1
(43) Pub. Date: Dec. 5, 2024

(54) HYBRID WELDING SYSTEMS AND HYBRID WELDING POWER SUPPLIES

(71) Applicant: Illinois Tool Works Inc., Glenview, IL (US)

(72) Inventors: Todd Earl Holverson, Appleton, WI (US); Craig Steven Knoener, Appleton, WI (US)

(21) Appl. No.: 18/663,728

(22) Filed: May 14, 2024

Related U.S. Application Data
(60) Provisional application No. 63/505,144, filed on May 31, 2023.

(51) Int. Cl. B23K 9/10

(52) U.S. Cl. CPC B23K 9/1075

(57) ABSTRACT

Disclosed example welding-type power supplies include: a first DC/DC converter configured to convert a first voltage from a first energy storage device to an intermediate voltage, and to output the intermediate voltage to an intermediate bus; a second DC/DC converter configured to convert a second voltage from a second energy storage device to the intermediate voltage, and to output the intermediate voltage to the intermediate bus; power conversion circuitry configured to convert the intermediate voltage to a welding-type output; and control circuitry configured to: control the first DC/DC converter based on the first voltage and the intermediate voltage; control the second DC/DC converter based on the second voltage and the intermediate voltage; and control the power conversion circuitry.

### RELATED APPLICATIONS

The present application claims the benefit of U.S. Patent Application Ser. No. 63/505,144, filed May 31, 2023, entitled “HYBRID WELDING SYSTEMS AND HYBRID WELDING POWER SUPPLIES.” The entirety of U.S. Patent Application Ser. No. 63/505,144 is expressly incorporated herein by reference.

### FIELD OF THE DISCLOSURE

This disclosure relates generally to welding systems, and more particularly to hybrid welding modules and hybrid welding power supplies.

### BACKGROUND

Welding power supplies are typically powered using power sources such as utility or mains power or engine-driven generator power. Battery-powered welding sources have been offered, but the designs of such battery-powered welding sources are highly reliant on the specific design of the battery due to the dynamic and high-power nature of welding.

### SUMMARY

Hybrid welding systems and hybrid welding power supplies are disclosed, substantially as illustrated by and described in connection with at least one of the figures, as set forth more completely in the claims.

### BRIEF DESCRIPTION OF THE DRAWINGS

FIG. 1 is a block diagram of an example hybrid welding system in accordance with aspects of this disclosure.

FIG. 2 is a block diagram of another example hybrid welding system including a hybrid welding power supply, in accordance with aspects of this disclosure.

FIG. 3 illustrates an example user interface which may implement the user interface of FIGS. 1 and/or 2 to display a determined welding capacity and supported and/or unsupported values for welding parameters based on the determined welding capacity.

FIG. 4 illustrates another example user interface which may implement the user interface of FIGS. 1 and/or 2 to display a determined welding capacity and alternative parameters supported by the determined welding capacity.

FIGS. 5A and 5B illustrate a flowchart representative of example machine-readable instructions which may be executed by the control circuitry of FIGS. 1 and/or 2 to advise and control a hybrid welding power supply based on energy storage device(s).

FIG. 6 is a flowchart representative of example machine-readable instructions which may be executed by the battery monitor of FIGS. 1 and/or 2 to determine one or more properties of batteries connected to the hybrid welding power supply.

The figures are not necessarily to scale. Wherever appropriate, similar or identical reference numerals are used to refer to similar or identical components.

### DETAILED DESCRIPTION

Many different battery-powered portable tools exist, such as drills, saws, and lawn equipment. Batteries are a costly component for many power tools. In some cases, batteries are the most costly part of the battery-powered tool. Reuse of batteries is an important consideration at the point of purchase, and battery-powered tool users are motivated to repeatedly purchase the same brand of battery-powered tool or product due to the ability to reuse batteries, which are not typically interchangeable between different brands.

Disclosed example welding-type power supplies include power conversion circuitry to convert power from a range of different batteries having different properties to welding-type power. As a result, disclosed welding-type power supplies may reduce the cost of battery-powered welding-type operations by allowing an operator to connect one or more batteries, which are already owned or possessed by the operator for a different tool or equipment, and use the battery power to supply a welding-type operation. An operator would not have to purchase a dedicated battery that is designated for the welding-type power supply and, instead, may use batteries which have already been purchased for other purposes.

In some examples, a welding-type power supply converts battery power from multiple different batteries, simultaneously, to supply an intermediate bus, which supplies power conversion circuitry that outputs the welding-type power. For example, disclosed welding-type power supplies include conversion circuitry which may increase a voltage output by a lower-voltage battery to supply an intermediate bus having an intermediate voltage and/or decrease the voltage output by a higher-voltage battery to supply the intermediate voltage.

As an example, some lawn equipment batteries are in the range of 48V of output and 100 Ampere-hours (Ah) of capacity, for an output of approximately 4800 Watts for one hour. For a 30 V, 150 A weld (4500 W), such a lawn equipment battery would be able to provide adequate power for welding, and particularly for common repair welds which may be as short as a few minutes. Another common battery size is 40V output and 6 Ah capacity, for an output of approximately 240 W for one hour. An example weld at lower (e.g., colder) settings for repairing sheet metal may occur at 20V and 125 A, or 2500 W. The 40V, 6 Ah battery could sustain approximately 5 minutes of welding, which is sufficient to perform a significant portion of common repair tasks.

Some disclosed example welding-type power supplies may include generic battery connections, such as positive and negative wire terminals for connection of position and negative leads from a battery. Additionally or alternatively, disclosed example welding-type power supplies may include terminals for attachment of different adapters which can connect to specific brands and/or connectors of batteries.

Some disclosed example welding-type power supplies adapt the conversion of input power to welding-type power based on properties of the connected batteries, such as the output voltage of the battery, the battery capacity, or an output current limit of the battery, to avoid exceeding operating limits of the battery. Such properties may be determined by communication with the battery, testing the battery, and/or looking up properties of the battery based on user input and/or observed data such as model number. Other example properties that may be used to influence the conversion of battery power include a battery temperature, a battery temperature curve, a battery charge level, a battery charge capacity, a battery impedance, an upper current limit, a battery size, a battery chemistry, a battery brand, a battery model, a number of charge-discharge cycles, a battery ampere-hour rating, a battery voltage, a battery energy density, a specific energy density, a power density, and/or a battery discharge curve.

As used herein, the term “welding-type power” refers to power suitable for welding, plasma cutting, induction heating, CAC-A and/or hot wire welding/preheating (including laser welding and laser cladding). As used herein, the term “welding-type power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith.

As used herein, “hot swappable” refers to having the appropriate circuitry to enable attachment and detachment of a power-providing device without interruption of existing power being supplied to the system to which the hot swappable device is being attached or detached.

As used herein, a “bidirectional DC-DC converter” refers to any bidirectional circuit topology that converts voltage up and/or down in a first direction and converts voltage up and/or down in a second direction. Example bidirectional DC-DC converters include buck-boost and/or boost-buck topologies, a SEPIC converter, a Ćuk converter, or the like. For example, a bidirectional DC-DC converter may refer to a DC-DC converter that boosts voltage in one direction and bucks voltage in the opposing direction.

As used herein, the term “recognized battery unit” refers to a battery unit that is approved, authorized, and/or otherwise has identifiable minimum characteristics, such as charge state, nominal voltage, minimum voltage, maximum voltage, and/or charge capacity. Recognition can occur through signaling, measurement, and/or any other mechanism.

As used herein, a “circuit” includes any analog and/or digital components, power and/or control elements, such as a microprocessor, digital signal processor (DSP), software, and the like, discrete and/or integrated components, or portions and/or combinations thereof.

Disclosed example welding-type power supplies include: a first DC/DC converter configured to convert a first voltage from a first energy storage device to an intermediate voltage; a second DC/DC converter configured to convert a second voltage from a second energy storage device to the intermediate voltage; power conversion circuitry configured to convert the intermediate voltage to a welding-type output; and control circuitry configured to: control the first DC/DC converter based on the first voltage and the intermediate voltage; control the second DC/DC converter based on the second voltage and the intermediate voltage; and control the power conversion circuitry.

In some example welding-type power supplies, the first voltage and the second voltage are different nominal voltages. In some example welding-type power supplies, the control circuitry is configured to determine the intermediate voltage based on at least one of the first voltage or the second voltage. In some example welding-type power supplies, the control circuitry is configured to control the first DC/DC converter and the second DC/DC converter based on a predetermined intermediate voltage.

In some example welding-type power supplies, the control circuitry is configured to: in response to detecting connection of the first energy storage device, determine the first voltage using a first voltage sensor; and in response to detecting connection of the second energy storage device, determine the second voltage using a second voltage sensor.

Some example welding-type power supplies further include communication circuitry configured to communicate with at least one of the first energy storage device or the second energy storage device. In some example welding-type power supplies, the control circuitry is configured to determine one or more properties of the at least one of the first energy storage device or the second energy storage device via the communication circuitry. In some example welding-type power supplies, the one or more properties include at least one of a battery temperature, a battery temperature curve, a battery charge level, a battery charge capacity, a battery impedance, an upper current limit, a battery size, a battery chemistry, a battery brand, a battery model, a number of charge-discharge cycles, a battery ampere-hour rating, a battery voltage, a battery energy density, a specific energy density, a power density, or a battery discharge curve. In some example welding-type power supplies, the control circuitry is configured to control at least one of the first DC/DC converter or the second DC/DC converter based on the determined one or more properties.

Some example welding-type power supplies further include a third DC/DC converter configured to convert a third voltage from a third energy storage device to the intermediate voltage. In some example welding-type power supplies, at least one of the first energy storage device or the second energy storage device are detachable from the portable welding-type power supply. In some example welding-type power supplies, the at least one of the first energy storage device or the second energy storage device are hot-swappable.

Some example welding-type power supplies further include a user interface configured to receive inputs representative of one or more properties of the at least one of the first energy storage device or the second energy storage device, wherein the control circuitry is configured to control at least one of the first DC/DC converter or the second DC/DC converter based on the one or more properties. Some example welding-type power supplies further include a first adapter configured to accept a first physical battery connection and configured to couple the first energy storage device to the first DC/DC converter via a first terminal; and a second adapter configured to accept a second physical battery connection and configured to couple the second energy storage device to the first DC/DC converter via the first terminal.

Some disclosed example welding-type power supplies include: a DC/DC converter configured to: when coupled to a first energy storage device: determine one or more first properties of the first energy storage device; convert a first output voltage from the first energy storage device to an intermediate voltage based on the one or more first properties; and when coupled to a second energy storage device: determine one or more second properties of the second energy storage device; convert a second output voltage from the second energy storage device to the intermediate voltage based on the one or more second properties; and power conversion circuitry configured to convert the intermediate voltage to a welding-type output; and control circuitry configured to: control the DC/DC converter based on the one or more first properties or the one or more second properties; and control the power conversion circuitry.

Some example welding-type power supplies further include communication circuitry configured to communicate with at least one of the first energy storage device or the second energy storage device, in which the control circuitry is configured to determine the one or more first properties or the one or more second properties via the communication circuitry.

In some example welding-type power supplies, the DC/DC converter is configured to be coupled to the first energy storage device via a first physical adapter and coupled to the second energy storage device via a second physical adapter. Some example welding-type power supplies further include communication circuitry configured to communicate with at least one of the first adapter or the second adapter, in which the control circuitry is configured to determine the one or more first properties or the one or more second properties via the communication circuitry.

Some example welding-type power supplies further include a second DC/DC converter configured to be coupled to the first energy storage device or the second energy storage device simultaneously with the first DC/DC converter being coupled to a different one of the first energy storage device, the second energy storage device, or a third energy storage device.

Some disclosed example welding-type power supplies include: a DC/DC converter configured to: when coupled to a first energy storage device via a first adapter, convert a first output voltage from the first energy storage device to an intermediate voltage; and when coupled to a second energy storage device via a second adapter, convert a second output voltage from the second energy storage device to the intermediate voltage and output the intermediate voltage; power conversion circuitry configured to convert the intermediate voltage to a welding-type output; and control circuitry configured to: control the DC/DC converter based on a type of the connected energy storage device; and control the power conversion circuitry.

While the examples disclosed below are discussed with reference to hybrid welding systems, this disclosure is also applicable to other welding-type systems and welding-type power supplies.

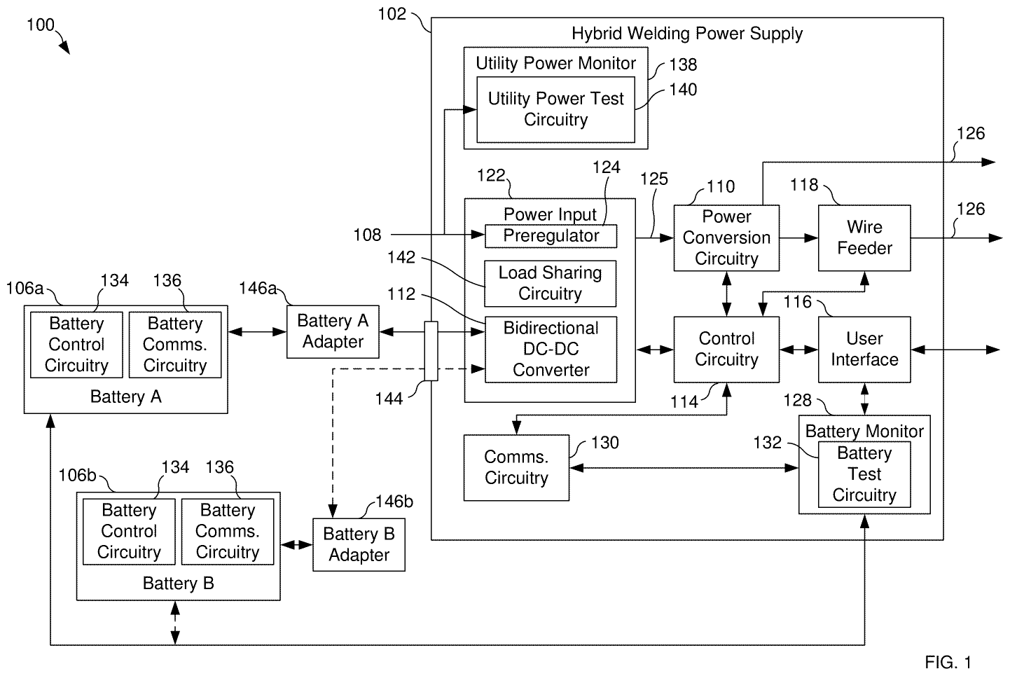

FIG. 1 is a block diagram of an example hybrid welding system 100. The example hybrid welding system 100 of FIG. 1 includes a hybrid welding power supply 102.

The hybrid welding power supply 102 is connected to one or more batteries 106. The batteries 106 may include any type or combination of types of energy storage devices, such as batteries, supercapacitors, thermal energy storage, chemical energy storage, and/or mechanical energy storage devices. While the following examples are discussed with reference to batteries, this disclosure applies to any other type of energy storage that is capable of adaptation for welding.

The hybrid welding power supply 102 may also be connected to utility power 108 (e.g., or mains power, or other type of AC input) from a power source such as an engine-driven generator, a battery-powered inverter supply, and/or any other power source. The hybrid welding power supply 102 may be powered by either or both of the batteries 106 or the utility power 108 at any given time.

When the hybrid welding power supply 102 is connected to both the utility power 108 and to the batteries 106, the hybrid welding power supply 102 may use the utility power 108 as a leading power source and/or may charge the batteries 106 using the utility power 108. Conversely, when energy is required that is not available from the utility power 108, the batteries 106 may provide power to the hybrid welding power supply 102 (e.g., to increase the available output power).

The hybrid welding power supply 102 includes power conversion circuitry 110, a bidirectional DC-DC converter 112, control circuitry 114, a user interface 116, and a wire feeder 118.

The power conversion circuitry 110 is a circuit that converts direct current (DC) power to welding power 126. The DC power used by the power conversion circuitry 110 is received from a power input 122. The power input 122 includes a preregulator 124 and/or the bidirectional DC-DC converter 112, and supplies one or more intermediate DC buses 125 with energy (e.g., a DC bus for the output of the preregulator 124 and one or more DC buses for the output of the bidirectional DC-DC converter 112, one DC bus for each battery connection, etc.). The preregulator 124 may include a rectifier to rectify the AC input from the utility power 108, pre-charging circuitry to provide an initial charge to the DC bus 125, power factor correction circuitry, and/or any other desired circuitry. The preregulator 124 further includes circuitry to convert the rectified AC input to the intermediate voltage on the DC bus 125 for providing power to the power conversion circuitry 110.

In some examples, the power input 122 includes load sharing circuitry, multiple converters, and/or multi-stage converters, to supply a DC bus with energy from multiple batteries or other energy storage devices. In some examples, the power input 122 may accept energy from different types of batteries simultaneously in addition to accepting energy from multiple batteries of the same type.

The power conversion circuitry 110 converts the energy present at the DC bus 125 (e.g., from the power input 122) to a weld output 126. For example, the power conversion circuitry 110 may include a switched mode power supply, which is controlled by the control circuitry 114 based on specified weld parameters and feedback.

The bidirectional DC-DC converter 112 is a circuit that converts input power (e.g., from the DC bus 125 powered by the utility power 108) to charge the batteries 106. The bidirectional DC-DC converter 112 also converts the stored power in the batteries 106 to converted power to output to the power conversion circuitry 110 (e.g., via one or more DC buses 125) for output to the power conversion circuitry 110.

The control circuitry 114 controls the power conversion circuitry 110 to output the weld output 126. The control circuitry 114 controls the bidirectional DC-DC converter 112 to convert power from the power input 122 to charge the batteries 106 and/or controls the bidirectional DC-DC converter 112 to convert power from the batteries 106 to provide the converted battery power to the power conversion circuitry 110. The control circuitry 114 further controls the bidirectional DC-DC converter 112 to charge the batteries 106 when the utility power 108 is available and at least a portion of the utility power 108 is available for charging the batteries 106 (e.g., the utility power 108 is not completely consumed by the power conversion circuitry 110 and/or the wire feeder 118). Conversely, the control circuitry 114 controls the bidirectional DC-DC converter 112 to convert power from the batteries 106 to provide the converted battery power to the power conversion circuitry 110 when a demand for welding power is higher than can be provided by the utility power 108.

The example wire feeder 118 includes a wire feed motor to provide electrode wire to the welding operation (e.g., when the welding operation involves a wire feeder, such as when gas metal arc welding, flux cored arc welding, etc.). When the welding operation involves a wire feeder, the control circuitry 114 controls the wire feeder 118. The wire feeder 118 may be powered by the weld output 126 or by another output from the power conversion circuitry 110. In some other examples, the wire feeder 118 may be a separate device connected to the weld output 126 external to the hybrid welding power supply 102.

The user interface 116 enables input to the hybrid welding power supply 102 and/or output from the hybrid welding power supply 102 to a user. The control circuitry 114 may indicate the state of charge of the batteries 106 and/or a mode of operation, such as a battery charging mode, an external power welding mode (e.g., welding mode powered by utility power), a combination welding-charging mode (e.g., welding and charging the batteries 106 using utility power 108), a battery powered welding mode, or a hybrid welding mode (e.g., welding boost mode powered by utility power and battery power), of the hybrid welding power supply 102 via the user interface 116.

The user interface 116 further includes inputs to allow an operator to specify welding parameters, such as a workpiece thickness, output voltage, output current, wire feed speed, welding wire diameter, welding wire type, welding process, pulse frequency, or pulse magnitude.

The example control circuitry 114 monitors the properties of connected batteries 106 and/or utility power 108 to provide information about the batteries, utility power, and welding capacity to the operator. For example, as the power available to the power input 122 from the batteries 106 increases, the control circuitry 114 may determine that thicker materials can be welded, a longer time, length, and/or number of welds of a given length are available to weld for a given set of parameters, use of the utility power 108 can be decreased, the types of usable weld processes increases, the usable consumable sizes (e.g., electrode diameters) increase, and/or other enhancements and/or augmentations to welding may become available. Conversely, as the power available from the batteries 106 decreases, the control circuitry 114 may determine that the thickness of materials that can be welded decreases, less time is available to weld for a given set of parameters, more utility power 108 may be needed, the types of usable weld processes are limited, the usable consumable sizes (e.g., electrode diameters) decrease, and/or the hybrid welding power supply 102 becomes otherwise limited.

The control circuitry 114 receives and uses properties of the batteries 106 to determine welding capacity and supported values for welding parameters, and to control the conversion of battery power by the bidirectional DC-DC converter 112 to supply the DC bus 125. For example, the control circuitry 114 may control the DC-DC converter 112 to convert a first output voltage from the first battery 106a to an intermediate voltage of the DC bus 125 based on one or more first properties of the first battery 106a. When the second battery 106b is connected to the power supply 102, the control circuitry 114 may change the control the DC-DC converter 112 to convert a second output voltage from the second battery 106b to the intermediate voltage of the DC bus 125 based on one or more second properties of the second battery 106b. To determine the properties of the batteries 106, the example hybrid welding power supply 102 includes a battery monitor 128 and/or communications circuitry 130.

The battery monitor 128 may interface with the batteries 106 to determine one or more properties of the batteries 106. For example, the battery monitor 128 may include battery test circuitry 132 which can function as one or more loads to the batteries 106 while measuring changes in voltage, current, temperature, and/or other properties. Additionally or alternatively, the battery monitor 128 may supply a small current to one of the batteries 106 (e.g., from the utility power 108 or another one of the batteries 106) to determine the response. In still other examples, the battery test circuitry 132 may perform voltage and/or current measurements, and/or measure voltage and/or current over time, to learn or infer the properties of the batteries 106. By analyzing the response of the batteries 106, the battery monitor 128 can determine properties of the batteries 106 for use by the control circuitry 114 in determining welding capacity.

Some types of batteries 106 include battery control circuitry 134 and/or battery communications circuitry 136. For example, battery control circuitry 134 may control internal load balancing of the batteries 106, and/or battery communications circuitry 136 may allow for communication of battery information to external devices and/or implement control of one or more aspects of the batteries 106 by an external device. The example battery communications circuitry 136 of the batteries 106 and/or the communications circuitry 130 of the hybrid welding power supply 102 may be configured to communicate through any wired or wireless techniques. For example, the battery communications circuitry 136 and/or the communications circuitry 130 may communicate via serial communications through the battery contacts. In other examples, the battery communications circuitry 136 and/or the communications circuitry 130 may communicate wirelessly via radio frequency identification (RFID), near field communications (NFC), Bluetooth®, and/or any other close-proximity communications, or any other desired wireless communications technique.

The example hybrid welding power supply 102 further includes a utility power monitor 138. The utility power monitor 138 monitors the presence and properties of the utility power 108, and provides the properties of the utility power 108 to the control circuitry 114 to determine welding capacity. Example properties of the utility power 108 that may be monitored include AC voltage, number of phases, frequency, average current limit, peak current limit, a source type of the utility power (e.g., mains power, a battery-powered inverter, a fuel-driven generator, etc.), a circuit breaker type of the utility power, and/or a circuit breaker rating of the utility power. The utility power monitor 138 may receive one or more properties via the user interface 116 and/or by testing the utility power 108 via utility power test circuitry 140. The utility power test circuitry 140 may, for example, measure the AC voltage and/or frequency via a voltage monitor, and/or apply an impulse load to the utility power 108 to measure a current response. The properties of the utility power 108 may be provided to the control circuitry 114 for determination of welding capacity (e.g., in combination with the properties of the batteries 106).

The example power input 122 may further include load sharing circuitry 142. The load sharing circuitry 142 controls a balance of power input from the utility power 108 and the one or more batteries 106. For example, the control circuitry 114 may control the load sharing circuitry 142 to cause relatively more power to be drawn from the utility power 108 to preserve battery life and/or avoid unnecessary battery discharge. The control circuitry 114 may also control the load sharing circuitry 142 to cause relatively more power to be drawn from the batteries, such as to reduce high electricity costs and/or save fuel when utility power 108 is powered by an engine-driven (or other portable fuel-driven) source.

In the example of FIG. 1, the batteries 106a, 106b are connected to the power supply 102 via a battery input connector 144. The battery input connector 144 may be a generic connector (e.g., positive and negative terminals or leads) or may have one or more plugs, ports, or connectors. In some examples, the battery input connector 144 is configured to deter connection of multiple batteries to the same connector 144 to avoid undesirable direct connections between batteries of different types.

To adapt different types of batteries having different types of interfaces to the battery input connector 144, the batteries 106a, 106b may be supplied with or otherwise connected to respective battery adapters 146a, 146b, which electrically and physically interface with the batteries 106a, 106b to facilitate transfer of power from the batteries 106a, 106b to the DC-DC converter 112. The battery A adapter 146a accepts the physical battery connection of the battery A 106a, and is further coupled to the battery input connector 144 to couple the battery A 106a to the DC-DC converter 112. Similarly, the battery B adapter 146b accepts the physical battery connection of the battery B 106b, and is further coupled to the battery input connector 144 to couple the battery B 106b to the DC-DC converter 112. In the example of FIG. 1, only one of the adapters 146a, 146b can be connected to the battery input connector 144 at a time.

In some examples, the battery adapters 146a, 146b may include communications circuitry (similar to the battery communications circuitry 136) to communicate properties of a connected battery to the communications circuitry 130. For example, for a battery adapter 146a which is configured to interface with one specific model of battery unit, the battery adapter 146a may communicate known properties of that model of battery. Additionally or alternatively, for a battery adapter 146a which is configured to interface with a set of battery units having one or more consistent properties, and/or for which one or more properties can be determined by the adapter (e.g., based on the adapter 146a determining which of multiple terminals are used by the connected battery, by the adapter 146a communicating with the battery communications circuitry 136, etc.), the battery adapter 146a may communicate the determined properties of the connected battery 106a.

In some examples, the adapters 146a, 146b may be configured to be electrically and physically attached to multiple ones of the same type of battery. For example, the battery A adapter 146a may have ports to accept two or more batteries simultaneously, such that the battery A adapter 146a can connect the two or more batteries to the bidirectional DC-DC converter 112 simultaneously.

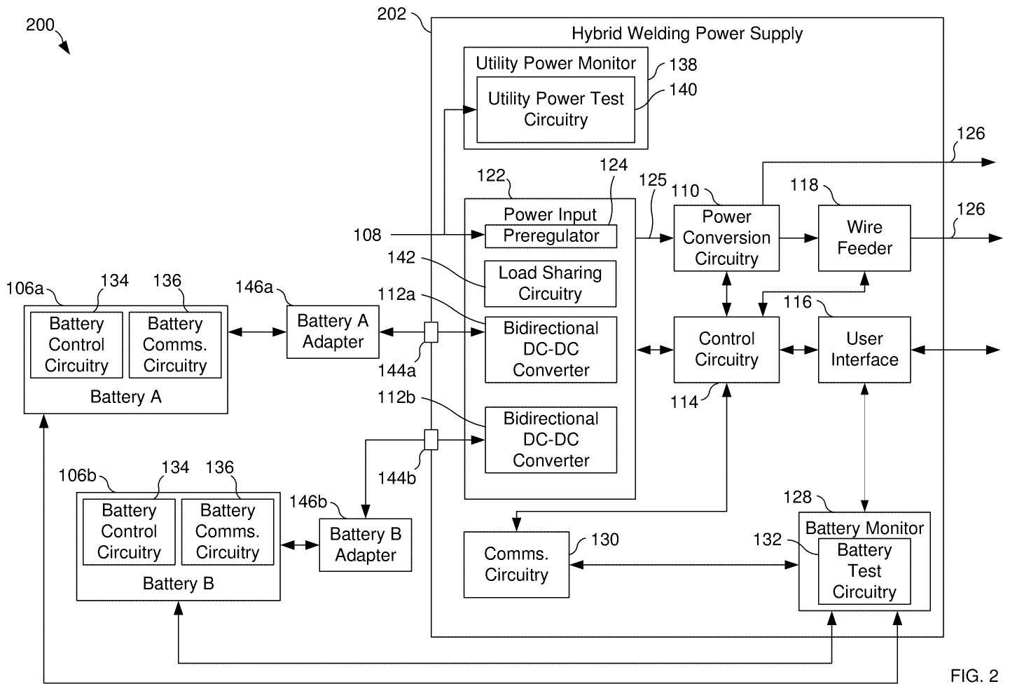

FIG. 2 is a block diagram of another example hybrid welding system 200 including a hybrid welding power supply 202. The example hybrid welding power supply 202 is similar to the hybrid welding power supply 102 of FIG. 1. The hybrid welding power supply 202 is similar to the hybrid welding power supply 102 of FIG. 1, with the exception that the hybrid welding power supply 202 includes multiple battery input connectors 144a, 144b and multiple bidirectional DC-DC converters 112a, 112b to simultaneously accommodate connection of multiple, different batteries 106a, 106b and convert power from multiple, different batteries 106a, 106b to supply the DC bus 125. The hybrid welding power supply 202 similarly includes the power conversion circuitry 110, the control circuitry 114, the user interface 116, the wire feeder 118, the power input 122, the DC bus 125, the battery monitor 128, the communications circuitry 130, and the utility power monitor 138 as described above with reference to FIG. 1.

In examples in which multiple, different batteries 106a, 106b are connected to the power supply 202, each of the DC-DC converters 112a, 112b converts the power from the connected battery 106a, 106b from the battery output voltage to the intermediate voltage of the DC bus 125. For example, one DC-DC converter 112a may be required to boost the voltage from the battery 106a to the intermediate voltage while the other DC-DC converter 112b may be required to buck the voltage from the battery 106b to the intermediate voltage. In some examples, the control circuitry 114 may determine and adjust the intermediate voltage based on the output voltages of the connected batteries 106a, 106b to increase the permitted power draw from the batteries 106a, 106b. The control circuitry 114 may then adjust control of the power conversion circuitry 110 based on the determined intermediate voltage at the DC bus 125 supplying the power conversion circuitry 110.

The example DC-DC converters 112 of FIGS. 1 and/or 2 are configured to enable hot-swapping of the batteries 106a, 106b by disconnection of a battery 106a and/or connection of a battery 106b to the power supply 202 while the power supply 202 is powered on. Either of the example welding power supplies 102, 202 of FIGS. 1 and/or 2 may include an internal energy storage device to provide power to the control circuitry 114 and/or other elements during swapping of batteries 106a, 106b to avoid power cycling and/or rebooting the power supply 202 to change batteries.

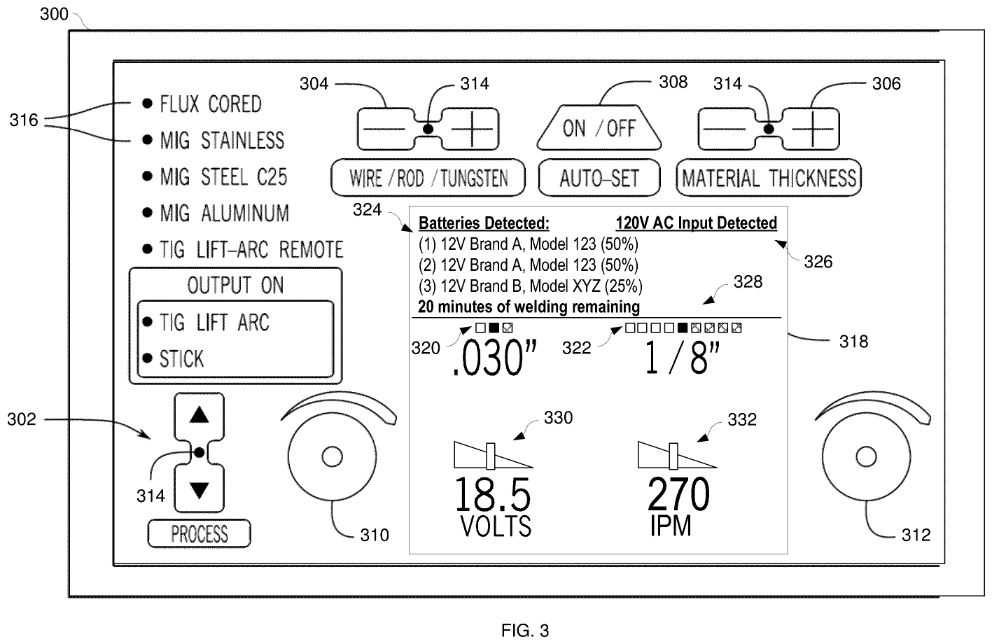

FIG. 3 illustrates an example user interface 300 which may implement the user interface 116 of FIGS. 1 and/or 2 to display a determined welding capacity and supported and/or unsupported values for welding parameters based on the determined welding capacity.

To enable an operator to specify welding parameters, the example user interface 300 includes a welding process selector 302, an electrode diameter adjustor 304, a material thickness adjustor 306, an Auto-Set selector 308, and welding parameter adjustment dials 310, 312.

The welding process selector 302 allows an operator or other user to select from a plurality of welding processes. For example, as depicted in FIG. 3, the welding process selector 302 may allow an operator to choose from welding processes, such as a stick welding process, a flux cored welding process, one or more metal inert gas (MIG) welding processes, one or more tungsten inert gas (TIG) welding processes, etc. In addition to general welding processes, in some examples, the welding process selector 302 may also allow the operator to select the material of the welding electrode. For example, the operator may further select a stainless steel, another type of steel, an aluminum electrode, and/or any other specific type of electrode for implementing the MIG process. In some examples, the welding process selector 302 may also allow an operator to select a desired combination of welding process (e.g., stick, MIG, TIG, etc.), electrode material type (e.g., steel, aluminum, etc.), and gas type (e.g., C25, C100, Argon, etc.), and subsequently elect to enable the Auto-Set function of the hybrid welding system 100 to automatically set the appropriate voltage and wire feed speed and/or amperage welding parameters. Example Auto-Set functionality is disclosed in greater detail in U.S. Pat. No. 8,604,389, which is herein incorporated by reference in its entirety.

The electrode diameter adjustor 304 allows selection of a diameter or size of a welding electrode, such as an electrode wire, an electrode rod, or tungsten electrode, depending on the type of welding process type selected. In the illustrated example, the electrode diameter adjustor 304 includes a “+” pushbutton to increase the electrode diameter setting and a “−” pushbutton to decrease the electrode diameter setting. The material thickness adjustor 306 allows selection of a material thickness of the workpiece. The material thickness adjustor 306 may include a “+” pushbutton to increase the material thickness setting and a “−” pushbutton to decrease the material thickness setting. The electrode diameter and material thickness settings, in conjunction, have an effect on the voltage and amperage (i.e., electrical current) required to perform a given welding procedure.

An operator or other user may select the Auto-Set function via the Auto-Set selector 308. When the Auto-Set feature is enabled (e.g., activated by the operator), the operator may only be required to input the respective electrode diameter and material thickness settings for the power conversion circuitry 110 to automatically adjust (e.g., increase or decrease) voltage, wire feed speed, amperage, and/or other parameters to appropriate settings. The Auto-Set selector 308 may be, for example, an on/off electrical switch or on/off pushbutton, which may be activated or deactivated, to allow the operator to enable or disable the Auto-Set function.

In the example of FIG. 3, the user interface 300 may include one or more light indicators 314 (e.g., LEDs in certain embodiments) to indicate whether the Auto-Set function is enabled or disabled. For example, in performing a MIG welding process, the operator may select the Auto-Set function, via the Auto-Set selector 308 and the one or more light indicators 314 may display a blue light, for example, or other indication to the operator that the Auto-Set function is enabled. Similarly, in some examples, the welding process selector 302 may be associated with a plurality of light indicators 316, each light indicator 316 being spatially aligned with a label corresponding to a respective welding process (e.g., “FLUX CORED”, “MIG STAINLESS”, and so forth). Manipulation of the welding process selector 302 changes the selected welding process, and the light indicator 316 that corresponds to the selected welding process displays, for example, a blue light, to indicate that the corresponding welding process has been selected.

The user interface 300 further includes a display screen 318 to output or convey information to the operator. The display screen 318 may be any display device capable of displaying visual graphical objects and/or alphanumeric texts relating to the setting of welding parameters, real-time operational statuses of the hybrid welding power supply 102, 202, etc. For example, the display screen 318 may be a liquid crystal display (LCD) screen, an organic LED (OLED) display, and/or any other type of display capable of outputting information to the operator. In the example of FIG. 3, the display screen 318 displays a selected electrode diameter (e.g., 0.030″), a selected material thickness (e.g., ⅛″), a selected power source welding voltage (e.g., 18.5 volts), and a selected wire feed speed (e.g., 270 inches per minute).

In some examples, any of the welding process selector 302, the electrode diameter adjustor 304, the material thickness adjustor 306, the Auto-Set selector 308, the welding parameter adjustment dials 310 and 312, may be displayed as graphical input devices on the display screen 318 (e.g., graphical buttons, graphical sliders, graphical knobs, etc.) instead of, or in addition to, physical input devices. For example, the display screen 318 may be a touchscreen configured to receive inputs from a user via such graphical input devices that are displayed on the display screen 318.

When the Auto-Set selector 308 is enabled, the display screen 318 may automatically display acceptable ranges of values of welding voltage and wire feed speed and/or amperage based upon inputs of the required electrode diameter and/or material thickness parameters (e.g., which are set based upon manipulation of the electrode diameter adjustor 304 and the material thickness adjustor 306). As used herein, an acceptable welding parameter value range may be a range of values within which the power conversion circuitry 110 holds the voltage and wire feed speed and/or amperage in response to an entered or estimated value of the electrode diameter and material thickness parameters, such that a weld may be effectively executed. For example, as depicted in FIG. 3, a welding operator may input an electrode diameter of 0.030″ and a material thickness of ⅛″ via the user interface 300. In response, the control circuitry 114 may automatically set appropriate welding parameter settings (e.g., 18.5 volts and 270 inches per minute) to effectively execute a weld for these particular electrode diameter and material thickness characteristics. The appropriate welding parameters may then be displayed via the display screen 318. The user interface 300 also includes welding parameter adjustment dials 310 and 312, which may be used to manually adjust (e.g., increase or decrease) the voltage and wire feed speed parameters and/or amperage parameter within acceptable ranges of values, depending on the particular type of welding process selected using the welding process selector 302.

Conversely, when the Auto-Set selector 308 is disabled, the operator may then manually adjust (e.g. increase or decrease) the welding voltage and wire feed speed parameters within an acceptable range of values (e.g., by manipulating the welding parameter adjustment dials 310 and 312, which correspond to the parameter displayed on the display screen 318 directly above respective welding parameter adjustment dial 310 and 312).

In some examples, the display screen 318 may display a plurality of discrete electrode diameter setting indicators 320 (e.g., displayed as a set of discrete points along a segmented line of a range of potentially selectable electrode diameter settings). A discrete electrode diameter setting indicator 320 corresponding to the currently selected electrode diameter setting (e.g., 0.030″ as illustrated in FIG. 3) is highlighted (e.g., a different color, a different brightness) relative to other setting indicators. Accordingly, when a user selects an electrode diameter via the electrode diameter adjustor 304, the appropriate discrete electrode diameter setting indicator 320 is selected. The plurality of discrete electrode diameter setting indicators 320 are intended to aid the user to know where, within a range of potentially selectable electrode diameter settings, the currently selected electrode diameter setting is. As described herein, the number of discrete electrode diameter setting indicators 320 that are displayed by the display screen 318 is determined based on other settings entered by the user. For example, based on other settings entered via the user interface 300, the display screen 318 will only display discrete electrode diameter setting indicators 320 that correspond to electrode diameter settings that make sense based on these other entered settings.

Similarly, the display screen 318 may display a plurality of discrete material thickness setting indicators 322 (e.g., displayed as a set of discrete points along a segmented line of a range of potentially selectable material thickness settings). A discrete material thickness setting indicator 322 corresponding to the currently selected material thickness setting (e.g., ⅛″) is highlighted (e.g., a different color, a different brightness) relative to other setting indicators. Accordingly, when a user selects a material thickness via the material thickness adjustor 306, the appropriate discrete material thickness setting indicator 322 is selected. The plurality of discrete material thickness setting indicators 322 are intended to aid the user to know where, within a range of potentially selectable material thickness settings, the currently selected material thickness setting is. As described herein, the number of discrete material thickness setting indicators 322 that are displayed by the display screen 318 is determined based on other settings entered by the user. For example, based on other settings entered via the user interface 300, the display screen 318 may only display discrete material thickness setting indicators 322 that correspond to material thickness settings that make sense based on these other entered settings.

The example user interface 300 also provides guidance to the operator based on determined properties of the batteries 106 and/or determined properties of the utility power 108. In the example of FIG. 3, the display 318 includes a battery indicator 324, a utility power indicator 326, and a welding capacity indicator 328. The battery indicator 324 may display information about detected batteries or other energy storage devices, such as the types of batteries (e.g., nominal voltages, brands, model numbers, etc.) and respective charge levels (e.g., remaining charge as a percentage of capacity, remaining ampere-hours, etc.). The utility power indicator 326 displays whether utility power 108 is connected and/or the voltage of the detected utility power. The welding capacity indicator 328 displays a remaining welding capacity (e.g., remaining welding duration using the one or more parameters, a length of welding using the one or more parameters, or a number of welds of predetermined length using the one or more parameters) that can be sustained by the power conversion circuitry 110, which is determined by the control circuitry 114 based on the determined properties of the batteries 106 and the properties of the utility power 108. While example information is displayed by the battery indicator 324 and the utility power indicator 326, any other properties may be displayed, and/or the operator may be able to navigate one or more menus or interfaces to access additional information or properties of the batteries 106 and the properties of the utility power 108.

Based on the properties of the batteries 106, the control circuitry 114 may determine that the welding capacity is insufficient to support one or more values for the welding parameters. As used herein, supported values of welding parameters refer to values for which the available energy is sufficient to perform at least a predetermined threshold duration, length, and/or other quantity of welding at those values. Conversely, as used herein, unsupported values of welding parameters refer to values for which the available energy is insufficient to perform at least the predetermined threshold duration, length, and/or other quantity of welding at those values.

In some examples, the control circuitry 114 may determine that some material thicknesses are not supported when the welding capacity is not sufficient to perform at least a threshold duration, length, and/or other quantity of welding using parameters (e.g., which may be derived from Auto-Set calculations or data). Based on the determination, the control circuitry 114 may control the display 318 to depict ones of the material thickness setting indicators 322 that correspond to the unsupported material thickness values using a different visual depiction than the indicators of the selected material thickness and different than other, supported material thicknesses. Similarly, the control circuitry 114 may control the display 318 to depict ones of the electrode diameter setting indicators 320 that correspond to the unsupported electrode diameter values using a different visual depiction than the indicators of the selected electrode diameters and different than other, supported electrode diameters.

Additionally or alternatively, the example display 318 may include a voltage range indicator 330 and/or a wire feed speed range indicator 332. The example voltage range indicator 330 is depicted as a ramp with a positioning bar. The ramp may indicate to the operator the effect on welding duration, length, and/or other quantity as the voltage parameter increases (e.g., reduced duration, length, and/or other quantity) or decreases (e.g., increased duration, length, and/or other quantity). The control circuitry 114 determines the supported voltages to correspond to the voltage range indicator 330, and displays the positioning bar along the ramp to illustrate to the operator the value of the selected voltage with respect to the range. In the illustrated example, the upper limit of the voltage range depicted in the voltage range indicator 330 is determined based on the threshold welding duration, length, and/or other quantity.

Similarly, the example wire feed speed range indicator 332 is depicted as another ramp with a positioning bar. The wire feed speed ramp may indicate to the operator the effect on welding duration as the wire feed speed (which affects current output) increases (e.g., reduced duration) or decreases (e.g., increased duration). The control circuitry 114 determines the supported wire feed speeds to correspond to the wire feed speed range indicator 332, and displays the positioning bar along the ramp to illustrate to the operator the value of the selected wire feed speed with respect to the range. In the illustrated example, the upper limit of the wire feed speed range depicted in the wire feed speed range indicator 332 is determined based on the threshold welding duration.

While the example indicators 330, 332 are depicted as ramps, in other examples either or both of the indicators 330, 332 may be depicted as trapezoids or other shapes. For example, a trapezoidal indicator may define a central preferred range as a balance of welding speed to welding duration (e.g., welding can be done faster without sacrificing excessive welding duration), and outer ranges that indicate less preferred ranges. For example, voltage and/or wire feed speed ranges above the preferred range may allow welding of thicker materials and/or faster travel speeds, but have substantially shorter available welding durations. Conversely, voltage and/or wire feed speed ranges below the preferred range may provide longer available welding durations, but offer reduced available ranges of material thicknesses and/or have lower travel speeds.

In some examples, the welding parameter adjustment dials 310 and 312 may be configured to only accept values that fall within the supported ranges of values for the welding parameters. For example, when manual adjustments are attempted via the welding parameter adjustment dials 310 and 312 that would bring their respective parameters to values outside of their respective acceptable range of values depicted by the indicators 330, 332, such manual adjustments may simply be ignored by the control circuitry 114, and not indicated as having any effect on the parameters via the display screen 318. In some examples, the control circuitry 114 may display information indicating a reason for ignoring or limiting adjustments via the adjustment dials 310, 312, such as indicating that utility power 108 is required (e.g., if utility power 108 is insufficient or not connected), that the connected batteries 106 should be charged (e.g., if the detected charge levels are less than 100% of capacity), and/or that additional battery capacity is required (e.g., if utility power 108 is connected and/or the battery charge levels are at 100%).

In some examples, the voltage range indicator 330 and/or the wire feed speed range indicator 332 may be displayed as an alternative to indicators associated with the Auto-Set function, which may display indicators based on suitability of welding according to the electrode diameter and material thickness parameters.

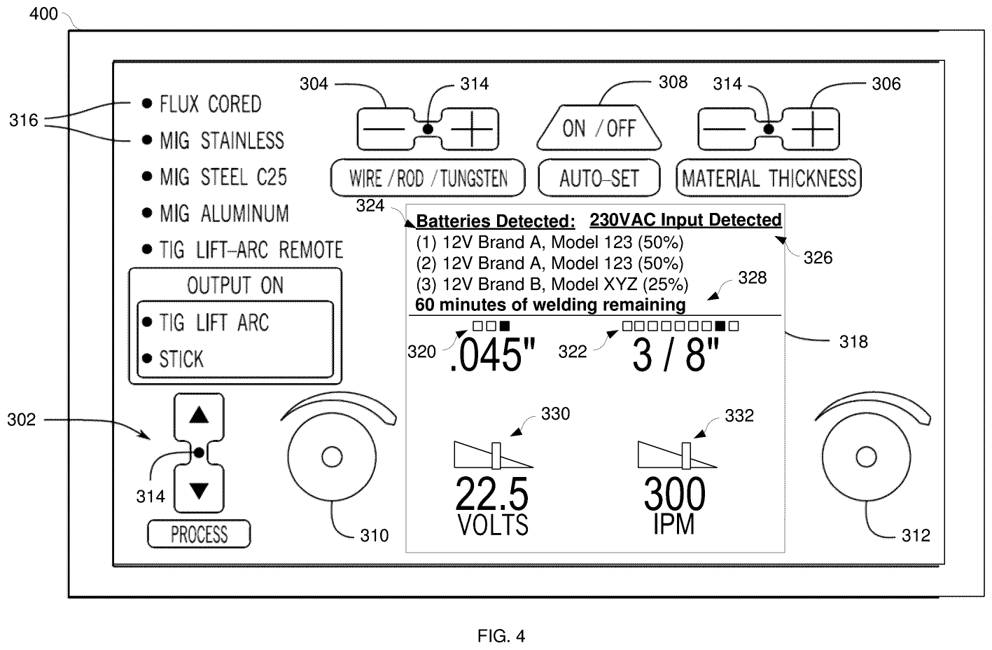

FIG. 4 illustrates another example user interface 400 which may implement the user interface 116 of FIGS. 1 and/or 2 to display a determined welding capacity and alternative parameters supported by the determined welding capacity. The example user interface 400 of FIG. 4 includes the welding process selector 302, the electrode diameter adjustor 304, the material thickness adjustor 306, the Auto-Set selector 308, the welding parameter adjustment dials 310, 312, the light indicators 314, 316, the display screen 318, the electrode diameter setting indicators 320, the material thickness setting indicators 322, the battery indicator 324, the utility power indicator 326, the voltage range indicator 330, and the wire feed speed range indicator 332 of FIG. 3.

In the example of FIG. 4, the battery monitor 128 detects three batteries, including identifying information and charge properties. The battery indicator 324 displays the properties of the detected batteries. Additionally, the utility power monitor 138 detects that 230 VAC input power is detected, and the utility power indicator 326 indicates the detected utility power input on the display 318. Due to the higher power available to the hybrid welding power supply 102, 202, the control circuitry 114 determines that the welding capacity is higher, and/or determines that more of the material thicknesses and electrode thicknesses are supported within the available welding capacity. Additionally, the electrode diameter setting indicator 320 and the material thickness setting indicator 322 indicate that more of the electrode diameters and material thicknesses are available than the lower welding capacity available in the example of FIG. 3.

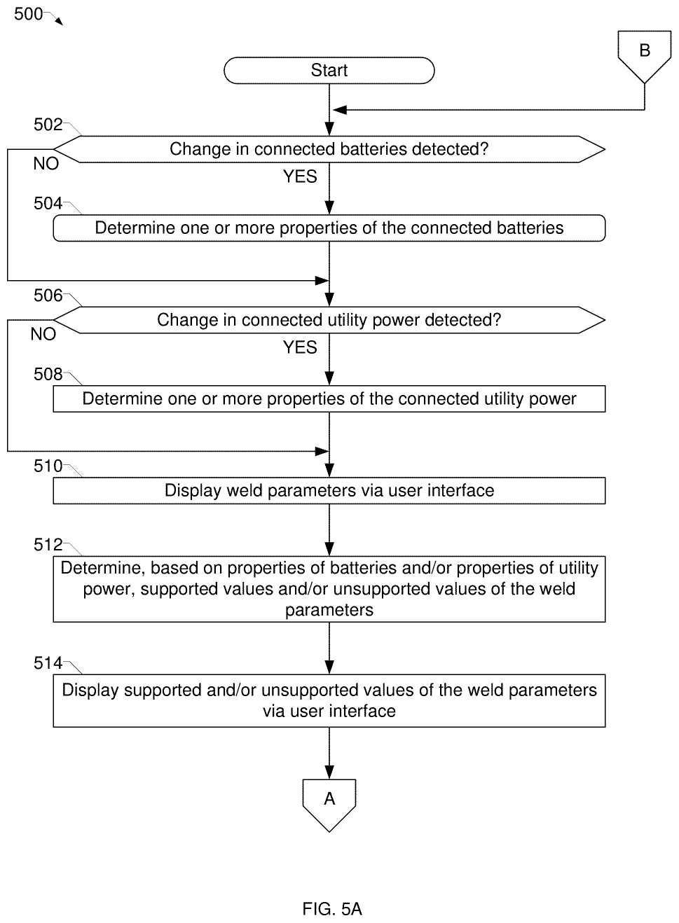

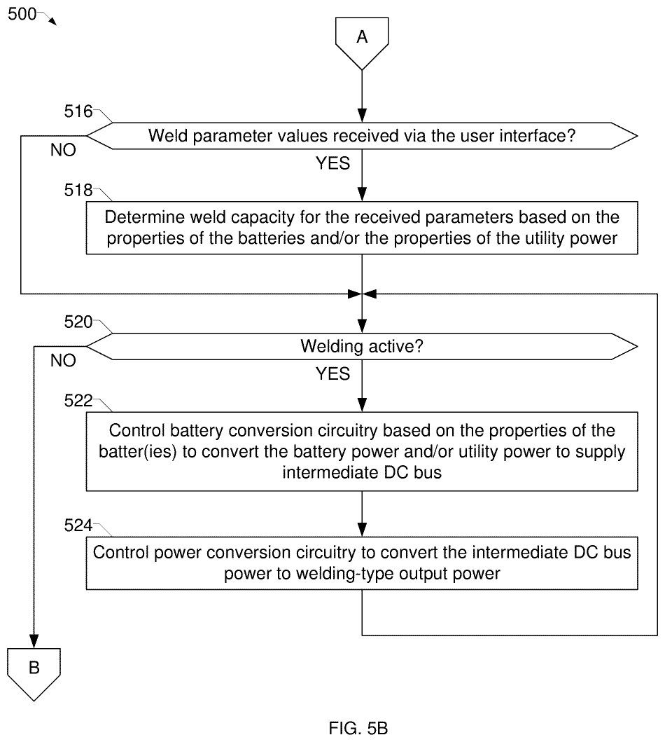

FIGS. 5A and 5B illustrate a flowchart representative of example machine-readable instructions which may be executed by the control circuitry 114 of FIGS. 1 and/or 2 to advise and control a hybrid welding power supply 102, 202 based on energy storage device(s). While the flowchart is discussed below with reference to batteries, the example instructions 500 are applicable to any type of energy storage devices.

At block 502, the battery monitor 128 determines whether a change in the connected batteries 106 is detected. For example, the battery monitor 128 may monitor to determine whether additional RFID tags are detected, and/or whether the voltage on one or more battery terminals has changed (e.g., terminals connecting each battery 106 to the hybrid welding power supply 102, 202). For example, as batteries 106 are connected or disconnected to the hybrid welding power supply 102, 202, the battery monitor 128 detects changes in voltage on the connection terminals. Additionally, the battery monitor 128 may detect changes in charge levels or other properties of the connected batteries.

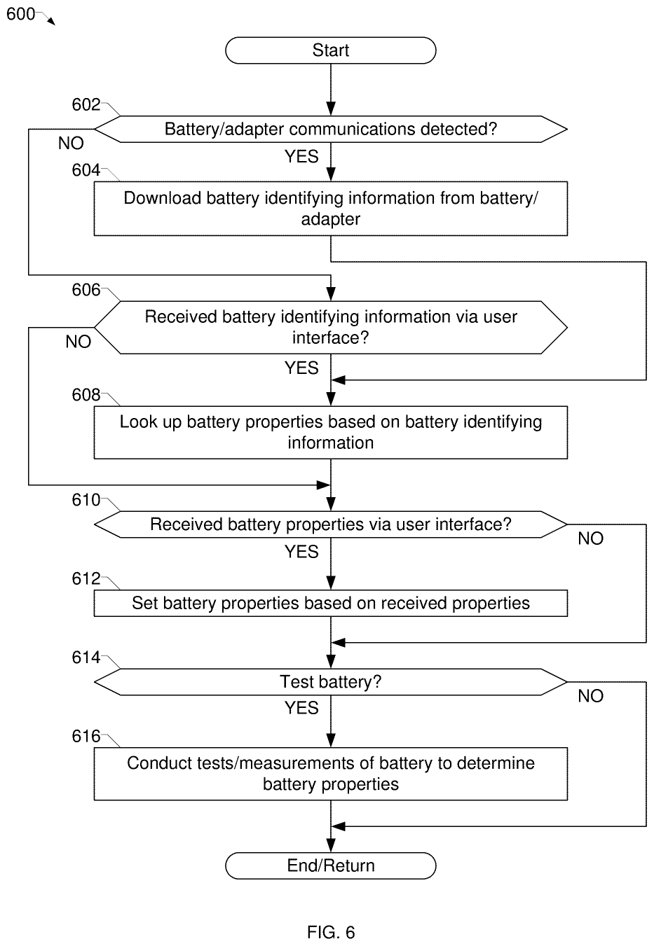

If a change in the connected batteries is detected (block 502), at block 504 the battery monitor 128 determines one or more properties of the connected batteries 106. For example, the battery monitor 128 may communicate with the battery communications circuitry 136 via the communications circuitry 130 to determine properties of the batteries 106. Additionally or alternatively, the battery test circuitry 132 may be used to measure one or more properties (e.g., voltage, temperature, etc.) of the batteries 106. An example implementation of block 504 is disclosed below with reference to FIG. 6.

After determining the properties of the batteries (block 504), or if no change in the batteries is detected (block 502), at block 506 the utility power monitor 138 determines whether a change in the connected utility power 108 has occurred. For example, the utility power monitor 138 may detect that utility power 108 has been connected or disconnected. If a change in utility power has been detected (block 506), at block 508 the utility power monitor 138 determines one or more properties of the connected utility power 108. For example, the utility power monitor 138 may use the utility power test circuitry 140 to measure the voltage, current limit, and/or other properties of the utility power 108.

After determining the properties of the utility power (block 508), or if a change in the utility power has not been detected (block 506), at block 510 the control circuitry 114 displays weld parameters via the user interface 116. For example, the control circuitry 114 may display one of the user interfaces 300, 400 of FIGS. 3 and/or 4 including welding parameters such as voltage, wire feed speed, welding process, and/or other parameters.

At block 512, the control circuitry 114 determines, based on the properties of the batteries 106 and/or properties of the utility power 108, supported values and/or unsupported values of the weld parameters. For example, the control circuitry 114 may determine electrode diameters and/or material thicknesses that are not supported (e.g., not capable of welding for at least a threshold duration), and/or limits on voltage, wire feed speed, current, and/or pulse parameters (e.g., pulse peak current).

At block 514, the control circuitry 114 displays the supported and/or unsupported values of the weld parameters via the user interface 116. For example, as illustrated in FIG. 3, the user interface 116 may show the electrode diameter setting indicators 320 with supported and/or unsupported indicators, the material thickness setting indicators 322 with supported and/or unsupported indicators, the voltage range indicator 330 with an upper limit on voltage, and/or a wire feed speed indicator 332 with an upper limit on wire feed speed.

Turning to FIG. 5B, at block 516 the control circuitry 114 determines whether weld parameter values have been received via the user interface 116. If weld parameter values have been received (block 516), at block 518 the control circuitry 114 determines a weld capacity for the received parameters, based on the properties of the batteries 106 and/or the properties of the utility power 108.

If welding parameter values are not received (block 516), at block 520 the control circuitry 114 determines whether welding is active. For example, the control circuitry 114 may determine whether welding has been initiated, whether welding is ongoing, and/or whether welding has stopped. If welding is active (block 520), at block 522 the control circuitry 114 controls battery conversion circuitry (e.g., the DC-DC converters 112a, 112b), based on the properties of the connected batteries 106a, 106b, to convert the battery power and/or utility power to supply the intermediate DC bus 125. For example, the control circuitry 114 may control the DC-DC converter 112 to boost or buck the output voltage of a connected battery 106a to the intermediate voltage of the DC bus 125, and/or control the DC-DC converter 112 to limit current drawn from the battery 106a to less than a current limit of the battery 106a.

At block 524, the control circuitry 114 controls the power conversion circuitry 110 to convert power from the intermediate DC bus 125 to the weld output 126. For example, the control circuitry 114 may control the power conversion circuitry 110 based on specified parameters, based on one or more properties of the connected batteries 106a, 106b, and/or based on connected utility power 108. Control then returns to block 520 while welding is active. When welding is not active (block 520), control returns to block 502.

FIG. 6 is a flowchart representative of example machine-readable instructions 600 which may be executed by the battery monitor 128 of FIGS. 1 and/or 2 to determine one or more properties of batteries connected to the hybrid welding power supply. The example instructions 600 may be executed to implement block 504 of FIG. 5A. While the flowchart is discussed below with reference to batteries, the example instructions 600 are applicable to any type of energy storage devices. Furthermore, while the flowchart is described below with reference to determining the properties for one example battery, the instructions 600 may be executed multiple times to determine the properties for multiple batteries and/or modified to determine the properties for multiple batteries at a time.

At block 602, the battery monitor 128 determines whether battery communications are detected. For example, the battery monitor 128 may determine, via the communications circuitry 130, whether communication can be established with battery communications circuitry 136, and/or with an adapter 146 connected to the battery 106, via wired communications (e.g., via the battery terminals) and/or wireless communications (e.g., via RFID, NFC, Bluetooth, Wi-Fi, etc.).

If battery communications are detected (block 602), at block 604 the battery monitor 128 downloads battery identifying information from the battery communications circuitry 136 and/or from the adapter 146 via the communications circuitry 130.

If battery communications are not detected (block 602), at block 606 the battery monitor 128 determines whether battery identifying information has been received via the user interface 116. For example, the operator may be permitted to enter battery identifying information, such as a model number, serial number, description, and/or other information, via the user interface 116.

After downloading the identifying information from the battery (block 604) or receiving the battery identifying information via the user interface 116 (block 606), at block 608 the battery monitor 128 (or the control circuitry 114) looks up battery properties based on the battery identifying information. For example, the battery monitor 128 may access a server, internal or external look up table, artificial intelligence model, fuzzy logic model, neural network, or other battery information repository to determine the properties of the battery based on the identifying information. Example battery properties may include a battery temperature, a battery temperature curve, a battery charge level, a battery charge capacity, a battery impedance, an upper current limit, a battery size, a battery chemistry, a battery brand, a battery model, a number of charge-discharge cycles, a battery ampere-hour rating, a battery voltage, a battery energy density, a specific energy density, a power density, and/or a battery discharge curve.

After looking up battery properties (block 608), or if battery identifying information has not been received (block 606), at block 610 the battery monitor 128 determines whether battery properties have been received via the user interface 116. For example, the user interface 116 may allow the operator to enter one or more battery properties into the user interface 116. If battery properties have been received via the user interface 116 (block 610), at block 612 the battery monitor 128 sets the battery properties based on the received properties.

After setting the battery properties based on the received properties (block 612), or if battery properties have not been received via the user interface 116 (block 610), at block 614 the battery monitor 128 determines whether to test the battery for one or more properties (e.g., desired properties which have not been received at other blocks). If the battery monitor 128 determines that the battery is to be tested (block 614), at block 616 the battery test circuitry 132 conducts tests and/or measurements of the battery to determine one or more battery properties. For example, the battery test circuitry 132 may test the battery to determine voltage, peak current, temperature, charge level, and/or any other testable properties. Additionally or alternatively, the battery test circuitry 132 may be used to verify properties entered by the operator or received via look up based on battery identifying information (e.g., from communications with the battery and/or via the user interface 116).

After testing and/or measuring the battery properties (block 616), or if the battery is not to be tested (block 614), the example instructions 600 may end and return control to block 506 of FIG. 5A.

The present methods and systems may be realized in hardware, software, and/or a combination of hardware and software. Example implementations include an application specific integrated circuit and/or a programmable control circuit.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. A welding-type power supply, comprising:
a first DC/DC converter configured to convert a first voltage from a first energy storage device to an intermediate voltage;
a second DC/DC converter configured to convert a second voltage from a second energy storage device to the intermediate voltage;
power conversion circuitry configured to convert the intermediate voltage to a welding-type output; and
control circuitry configured to:
control the first DC/DC converter based on the first voltage and the intermediate voltage;
control the second DC/DC converter based on the second voltage and the intermediate voltage; and
control the power conversion circuitry.

2. The welding-type power supply as defined in claim 1, wherein the first voltage and the second voltage are different nominal voltages.

3. The welding-type power supply as defined in claim 1, wherein the control circuitry is configured to determine the intermediate voltage based on at least one of the first voltage or the second voltage.

4. The welding-type power supply as defined in claim 1, wherein the control circuitry is configured to control the first DC/DC converter and the second DC/DC converter based on a predetermined intermediate voltage.

5. The welding-type power supply as defined in claim 1, wherein the control circuitry is configured to:
in response to detecting connection of the first energy storage device, determine the first voltage using a first voltage sensor; and
in response to detecting connection of the second energy storage device, determine the second voltage using a second voltage sensor.

6. The welding-type power supply as defined in claim 1, further comprising communication circuitry configured to communicate with at least one of the first energy storage device or the second energy storage device.

7. The welding-type power supply as defined in claim 6, wherein the control circuitry is configured to determine one or more properties of the at least one of the first energy storage device or the second energy storage device via the communication circuitry.

8. The welding-type power supply as defined in claim 7, wherein the one or more properties comprise at least one of a battery temperature, a battery temperature curve, a battery charge level, a battery charge capacity, a battery impedance, an upper current limit, a battery size, a battery chemistry, a battery brand, a battery model, a number of charge-discharge cycles, a battery ampere-hour rating, a battery voltage, a battery energy density, a specific energy density, a power density, or a battery discharge curve.

9. The welding-type power supply as defined in claim 7, wherein the control circuitry is configured to control at least one of the first DC/DC converter or the second DC/DC converter based on the determined one or more properties.

10. The welding-type power supply as defined in claim 1, further comprising a third DC/DC converter configured to convert a third voltage from a third energy storage device to the intermediate voltage, and to output the intermediate voltage.

11. The welding-type power supply as defined in claim 1, wherein at least one of the first energy storage device or the second energy storage device are detachable from the portable welding-type power supply.

12. The welding-type power supply as defined in claim 11, wherein the at least one of the first energy storage device or the second energy storage device are hot-swappable.

13. The welding-type power supply as defined in claim 1, further comprising a user interface configured to receive inputs representative of one or more properties of the at least one of the first energy storage device or the second energy storage device, wherein the control circuitry is configured to control at least one of the first DC/DC converter or the second DC/DC converter based on the one or more properties.

14. The welding-type power supply as defined in claim 1, further comprising:
a first adapter configured to accept a first physical battery connection and configured to couple the first energy storage device to the first DC/DC converter via a first terminal; and
a second adapter configured to accept a second physical battery connection and configured to couple the second energy storage device to the first DC/DC converter via the first terminal.

15. A welding-type power supply, comprising:
a DC/DC converter configured to:
when coupled to a first energy storage device:
determine one or more first properties of the first energy storage device;
convert a first output voltage from the first energy storage device to an intermediate voltage based on the one or more first properties; and
when coupled to a second energy storage device:
determine one or more second properties of the second energy storage device;
convert a second output voltage from the second energy storage device to the intermediate voltage based on the one or more second properties; and
power conversion circuitry configured to convert the intermediate voltage to a welding-type output; and
control circuitry configured to:
control the DC/DC converter based on the one or more first properties or the one or more second properties; and
control the power conversion circuitry.

16. The welding-type power supply as defined in claim 15, further comprising communication circuitry configured to communicate with at least one of the first energy storage device or the second energy storage device, the control circuitry configured to determine the one or more first properties or the one or more second properties via the communication circuitry.

17. The welding-type power supply as defined in claim 15, wherein the DC/DC converter is configured to be coupled to the first energy storage device via a first physical adapter and coupled to the second energy storage device via a second physical adapter.

18. The welding-type power supply as defined in claim 17, further comprising communication circuitry configured to communicate with at least one of the first adapter or the second adapter, the control circuitry configured to determine the one or more first properties or the one or more second properties via the communication circuitry.

19. The welding-type power supply as defined in claim 15, further comprising a second DC/DC converter configured to be coupled to the first energy storage device or the second energy storage device simultaneously with the first DC/DC converter being coupled to a different one of the first energy storage device, the second energy storage device, or a third energy storage device.

20. A welding-type power supply, comprising:
a DC/DC converter configured to:
when coupled to a first energy storage device via a first adapter, convert a first output voltage from the first energy storage device to an intermediate voltage; and
when coupled to a second energy storage device via a second adapter, convert a second output voltage from the second energy storage device to the intermediate voltage;
power conversion circuitry configured to convert the intermediate voltage to a welding-type output; and
control circuitry configured to:
control the DC/DC converter based on a type of the connected energy storage device; and
control the power conversion circuitry.
